(19) United States
(12) Patent Application Publication
(10) Pub. No.: US 2023/0367039 A1
(43) Pub. Date: Nov. 16, 2023

(54) Optical Film Structure

(71) Applicant: VACTRONICS TECHNOLOGIES INC., MIAOLI COUNTY (TW)

(72) Inventors: Yung-Chun WANG, MIAOLI COUNTY (TW); Hsang-Yang LIN, MIAOLI COUNTY (TW); Tsung-Yen TSAI, MIAOLI COUNTY (TW); Huang-Ming CHANG, MIAOLI COUNTY (TW)

(21) Appl. No.: 18/187,306

(22) Filed: Mar. 21, 2023

(30) Foreign Application Priority Data
May 12, 2022 (TW) 111117757

(51) Int. Cl. G02B 1/10; G02B 5/20

(52) U.S. Cl. CPC G02B 1/10; G02B 5/20

(57) ABSTRACT

An optical film structure includes film sets, each of which includes a first film and a second film that are stacked up in an axis. For each of the film sets, the first film has a higher refractive index than the second film, and a thickness ratio of the first film to the second film is larger than 0 and is less than or equal to 0.28. Therefore, the optical film structure is applicable to a variety of devices or components whose filter properties change with different incident angles of light.

### BACKGROUND

### Field of the Invention

The present invention relates to an optical film structure, and more particularly to an optical film structure with high angle and high spectral shift.

### Description of Related Art

In the existing optical filters using dielectric films, most of them have spectral shift due to the difference in the incident angle of light. Therefore, the coating-based optical application is limited and cannot be effectively utilized.

In the case of an optical film structure 1 applied to the Bragg reflector and having a film configuration as shown in FIG. 1, the optical film structure 1 includes high refractive films 11 and low refractive films 12 that are stacked up in an alterative manner, the thickness of the respective high refractive film 11 is the same as that of the respective low refractive film 12, and the thicknesses of the high refractive films 11 and the low refractive films 12 are about ¼λ, (λ is the wavelength of the incident light). A transmittance test of the optical film structure 1 is performed on the test condition that the optical film structure 1 is set in the test environment shown in FIG. 2 (that is, the optical film structure is formed on the glass substrate, and above the optical film structure and below the glass substrate GLASS are air (i.e., atmospheric environment)), and then is illuminated by light with a reference wavelength of 650 nm and the incident angles θ of 0 degree and 30 degrees, respectively. The transmittance test results are shown in FIG. 3 that the wavelength corresponding to the transmittance of 50% in the spectral curve B1 corresponding to the incident angle of 0 degree is 552 nm, the wavelength corresponding to the transmittance of 50% in the spectral curve B2 corresponding to the incident angle of 30 degrees is 532 nm, and the wavelength of the spectral curve B2 shifts by 20 nm relative to the wavelength of the spectral curve B1 at the transmittance of 50%.

Take an optical film structure 2, applied to an optical filter and having the film configuration shown in FIG. 4, as an example where the optical film structure 2 includes high refractive films 21 and low refractive films 22 stacked up in an alterative manner, the thicknesses of the four high refractive films 21 from top to bottom are about 1.3027 times, 1.1523 times, 1.1479 times and 1.1479 times of ¼λ, respectively, and the thicknesses of the four low refractive films 22 from top to bottom are about 1.1950 times, 1.1108 times, 1.0802 times and 1.1082 times of ¼λ, respectively. Transmittance test is performed on the optical film structure 2 in the test condition that the optical film structure 2 is set in the test environment shown in FIG. 2, and then is illuminated by the light with the reference wavelength of 573 nm and the incident angles θ of 0 degree and 30 degrees, respectively.

The transmittance test results are shown in FIG. 5 that the wavelength corresponding to the transmittance of 50% in the spectral curve B3 corresponding to the incident angle of 0 degree is 552 nm, the wavelength corresponding to the transmittance of 50% in the spectral curve B4 corresponding to the incident angle of 30 degrees is 529 nm, and the wavelength of the spectral curve B4 shifts by 23 nm relative to the wavelength of the spectral curve B3 at the transmittance of 50%.

Therefore, how to make the optical film with a spectral shift caused by the difference of incident angles of light still be used effectively is an issue to be solved.

### SUMMARY

One objective of the present invention is to provide an optical film structure that can increase the spectral shift caused by the difference in the incident angle of light.

Another objective of the present invention is to provide an optical film structure which can be used effectively even in the presence of spectral shift caused by the difference of the incident angles of light.

Yet another objective of the present invention is to provide an optical film structure which can be applied to various devices or components that require their filtering properties to change with the different incident angles of light, such as, but not limited to, devices or components that have the anti-spy function (or anti-peeping function), color changing with the different incident angles of light, or wavelength filtering changing with the different incident angles of light.

To achieve the above objectives, an optical film structure in accordance with an embodiment of the present invention comprises a plurality of film sets stacked along an axis, and each film set of the plurality of film sets including a first film and a second film which are stacked, wherein for each film set of the plurality of film sets, a refractive index of the first film is greater than a refractive index of the second film, and a thickness ratio of the first film to the second film is greater than 0 and less than or equal to 0.28.

In some embodiments, in one film set of the plurality of film sets, the thickness ratio of the first film to the second film is 0.01˜0.27.

In some embodiments, in one film set of the plurality of film sets, a thickness of the first film is 0.08-0.50 times of a quarter of a wavelength of incident light, and a thickness of the second film is 1.80-6.20 times of a quarter of the wavelength of the incident light.

In some embodiments, in one film set of the plurality of film sets, a thickness of the first film is less than or equal to 0.5 times of one quarter of a wavelength of the incident light, and a thickness of the second film is greater than or equal to 1.80 times of one quarter of the wavelength of the incident light. Or, in each film set of the plurality of film sets, the thickness of the first film is less than or equal to 0.5 times of one quarter of the wavelength of the incident light, and the thickness of the second film is greater than or equal to 1.80 times of one quarter of the wavelength of the incident light.

In some embodiments, in one of the film sets, a thickness of the first film is 0.2 times of a quarter of a wavelength of an incident light, and a thickness of the second film is 2 times of a quarter of the wavelength of the incident light.

In some embodiments, in one of the film sets, a material of the first film is titanium dioxide, tantalum pentoxide, niobium pentoxide, silicon oxide, silicon nitride, tin dioxide or zinc sulfide.

In some embodiments, a material of the second film is silicon dioxide, magnesium fluoride, barium fluoride, aluminum fluoride or strontium fluoride.

In some embodiments, the first film of each of the film sets contacts the second film of another adjacent film set, and the first film of each of the film sets is closer to the light incidence end than the second film.

In some embodiments, the thickness ratio of the first film to the second film of each of the film sets is the same. Or, the thickness ratio of the first film to the second film of one of the film sets is different from the thickness ratio of the first film to the second film of another of the film sets.

### BRIEF DESCRIPTION OF THE DRAWINGS

After studying the detailed description in conjunction with the following drawings, other aspects and advantages of the present invention will be discovered:

FIG. 1 is a schematic diagram of a conventional optical film structure;

FIG. 2 is a schematic diagram of an optical film structure arranged on a glass substrate for a transmittance test;

FIG. 3 is a schematic spectrogram of the optical film structure of FIG. 1 in the transmittance test under different incident angles;

FIG. 4 is a schematic diagram of another conventional optical film structure;

FIG. 5 is a schematic spectrogram of the optical film structure of FIG. 4 in the transmittance test under different incident angles;

FIG. 6 is a schematic diagram of an optical film structure according to an embodiment of the present invention; and

FIGS. 7 to 9 are schematic spectrograms of optical film structures with different film configurations in the transmittance test according to different embodiments of the present invention.

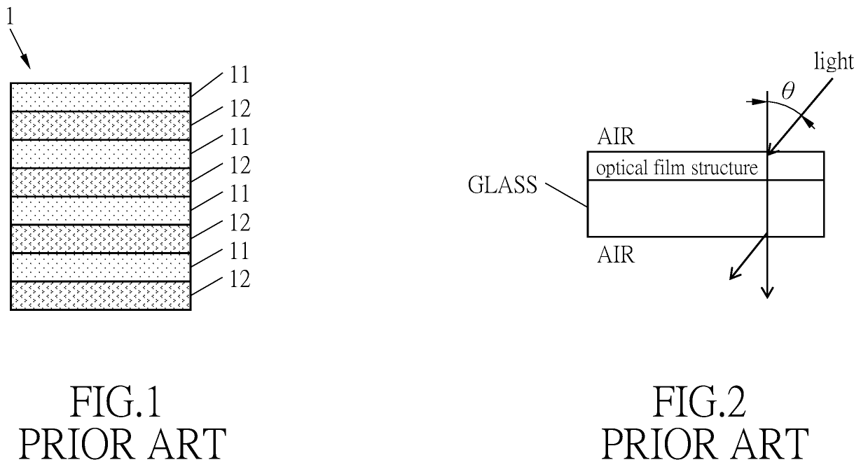

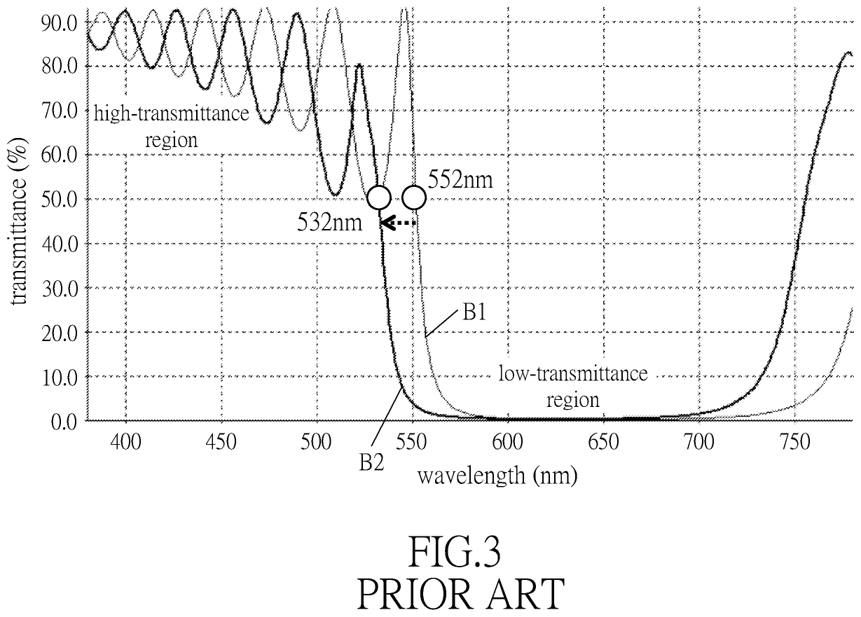

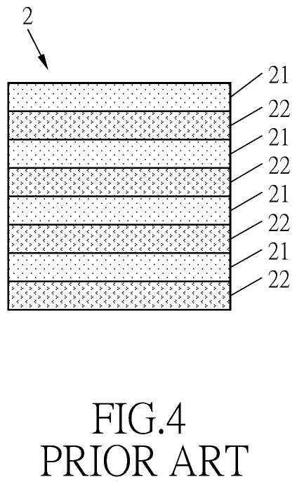

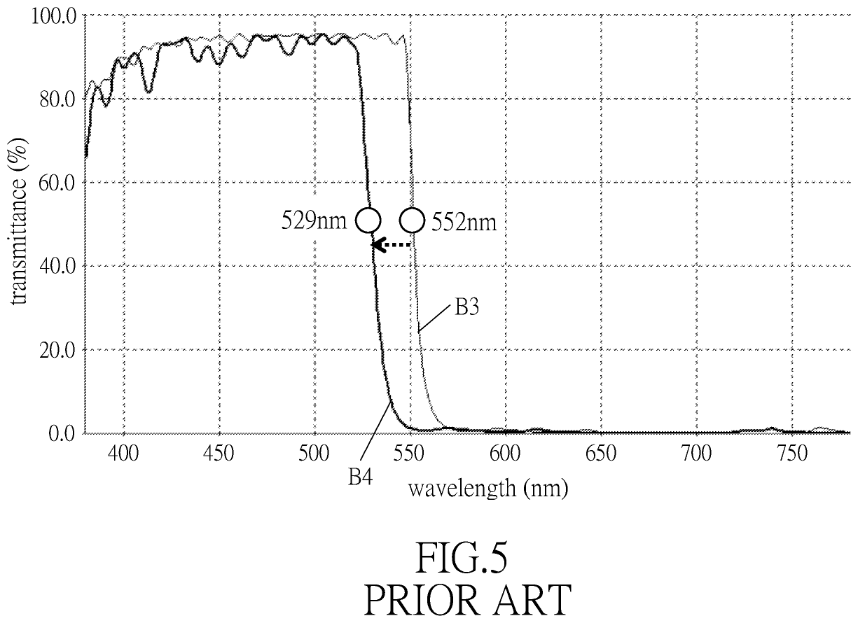

### DETAILED DESCRIPTION

In the following detailed description, many specific details are set forth in order to provide a thorough understanding of the invention. However, those skilled in the art will understand that the invention can be practiced without these specific details. In other cases, well-known methods, processes, and/or elements are not described in detail so as not to obscure the invention.

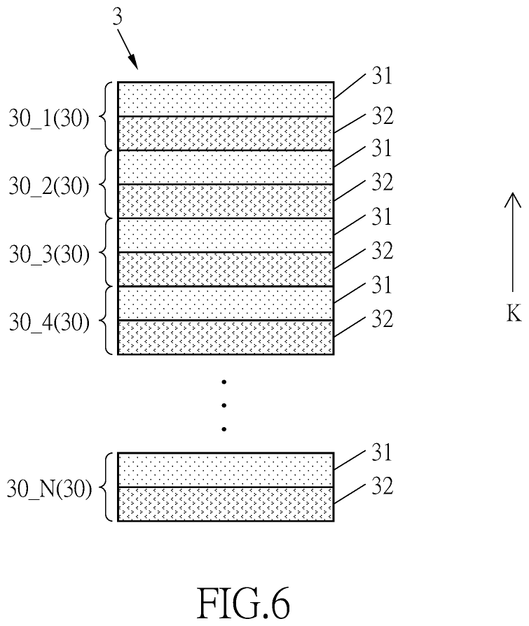

Referring to FIG. 6, an optical film structure 3 provided according to an embodiment of the present invention can be manufactured by, for example, but not limited to, physical vapor deposition (PVD) or chemical vapor deposition (CVD), and includes N film sets 30, that is, film sets 30_1˜30_N. N is a positive integer greater than or equal to 2, preferably a positive integer greater than or equal to 5. The film sets 30_1˜30_N are stacked along an axis K. Each film set 30 includes a first film 31 and a second film 32 stacked along the axis K. The first film 31 of each film set 30 contacts the second film 32 of another film set 30 adjacent thereto. In this embodiment, the film set 30_1 is closest to the light incidence end, the film set 30_N is farthest away from the light incidence end, and for each film set 30, the first film 31 is closer to the light incidence end than the second film 32; and however, this invention is not limited thereto. Other embodiments can also be changed to other configurations. For example, the film set 30_N is closest to the light incidence end, and the film set 30_1 is farthest away from the light incidence end. Or, for example, the first film 31 of each film set 30 is farther away from the light incidence end than the second film 32.

The first film 31 is a high refractive film, and the second film 32 is a low refractive film, so the refractive index of the first film 31 is greater than that of the second film 32. The materials of the first film 31 include, for example, but are not limited to, titanium dioxide, tantalum pentoxide, niobium pentoxide, silicon oxide, silicon nitride, tin dioxide, zinc sulfide or other existing optical coating materials. The materials of the second film 32 include, for example, but are not limited to, silicon dioxide, magnesium fluoride, barium fluoride, aluminum fluoride, strontium fluoride or other existing optical coating materials.

The thickness ratio of the first film 31 to the second film 32 of at least one of the film sets 30 is about greater than 0 and less than or equal to 0.28 (that is, the thickness of the first film 31 is at least less than or equal to about 0.28 times the thickness of the second film 32), preferably 0.01˜0.27.

For example, the thickness ratio of the first film 31 to the second film 32 is about 0.02, 0.03, 0.06, 0.08, 0.09 or 0.10. Specifically, in at least one of the film sets 30, the thickness of the first film 31 is, for example, but not limited to, equal to or less than about 0.08˜0.50 times of ¼λ, preferably 0.09˜0.48 times of ¼λ, such as, but not limited to, 0.10, 0.11, 0.18, 0.19, 0.20, 0.23 or 0.24 times of ¼λ; and the thickness of the second film 32 is, for example, but not limited to equal to or greater than about 1.80˜6.20 times of ¼λ, preferably 1.82˜6.18 times of ¼λ, such as, but not limited to, 1.85, 2.0, 2.17, 2.18, 2.2, 3.8, 3.81, 3.82, 3.90, 3.94 or 6.18 times of ¼λ. λ is the wavelength of the incident light.

In the invention, by arranging a thinner first film 31 and a thicker second film 32 in the same film set 30, the spectral shift of the optical film structure 3 at the light incident angle of 0 degree to 30 degrees can be greater than or equal to 30 nm, so as to achieve the purpose of high angle (i.e., the incident angle is greater than or equal to 30 degrees) and high spectral shift.

In this way, the optical film structure 3 can be applied to various devices or components that require their filtering properties to change with the different incident angles of light, such as, but not limited to, devices or components that have the function of anti-spy, color changing with the different incident angles of light, or wavelength filtering changing with the different incident angles of light.

The following examples of the optical film structure 3 with different film configurations are presented for a transmittance test to illustrate the spectral shift of the optical film structure 3 of the invention. For the convenience of explanation and test, the optical film structure 3 of these examples adopts the film configuration containing only four film sets 30, namely, the film set 30_1 to the film set 30_4, and N=4.

### First Example

In the four film sets 30 of the optical film structure 3 of the first example, these four film sets 30 have the same thickness, and the thickness ratio of the first film 31 to the second film 32 of each film set 30 is the same. The thickness of the first film 31 of each film set 30 is about 0.2 times of ¼λ, and the thickness of the second film 32 is about 2 times ¼λ.

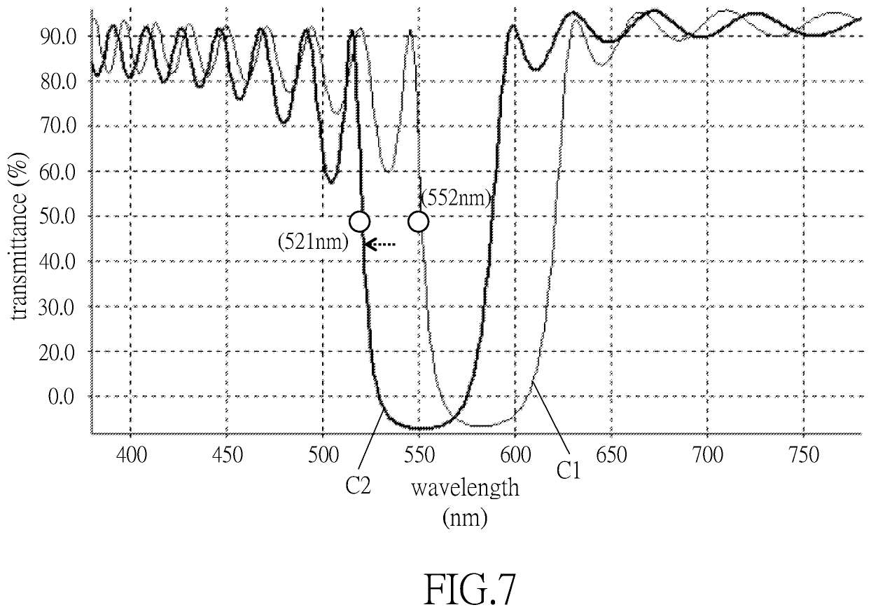

The transmittance test is to set the optical film structure 3 of the first example in the test environment as shown in FIG. 2, and then illuminate the optical film structure 3 with light with a reference wavelength of 530 nm and incident angles of 0 and 30 degrees respectively. The test results are shown in FIG. 7, where the wavelength corresponding to the transmittance of 50% in the spectral curve C1 corresponding to the incident angle of 0 degree is 552 nm, the wavelength corresponding to the transmittance of 50% in the spectral curve C2 corresponding to the incident angle of 30 degrees is 521 nm, and the wavelength of the spectral curve C2 shifts by 31 nm relative to the wavelength of the spectral curve C1 at the transmittance of 50%.

### Second Example

In the four film sets 30 of the optical film structure 3 of the second example, the thicknesses of these four film sets 30 are the same, and the thickness ratio of the first film 31 to the second film 32 of each film set 30 is the same. The thickness of the first film 31 of each film set 30 is about 0.5 times of ¼λ, and the thickness of the second film 32 is about 1.85 times of ¼λ.

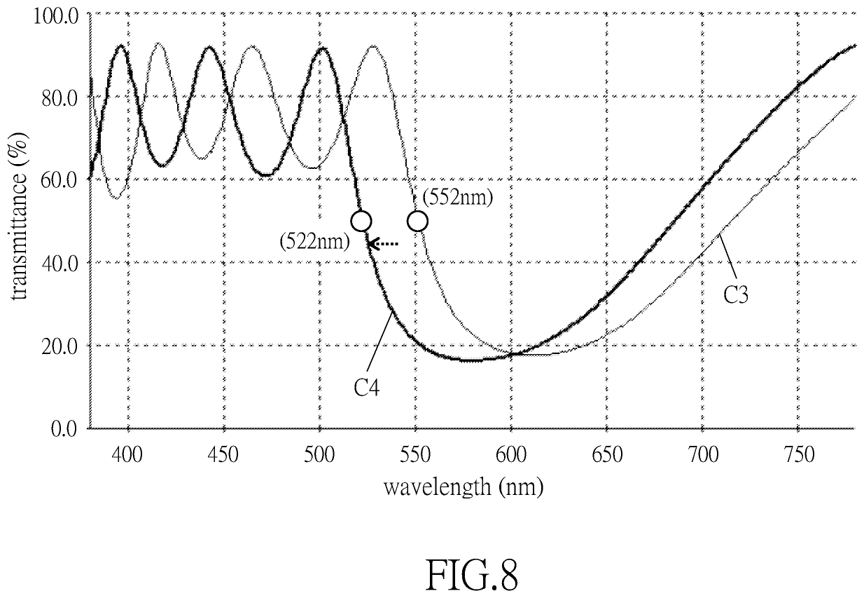

The transmittance test is to set the optical film structure 3 of the second example in the test environment as shown in FIG. 2, and then illuminate the optical film structure 3 with light with a reference wavelength of 543 nm and the incident angles of 0 and 30 degrees respectively. The test results are shown in FIG. 8, where the wavelength corresponding to 50% transmittance in the spectral curves C3 corresponding to the incident angle of 0 degree is 552 nm, and the wavelength corresponding to the 50% transmittance in the spectral curves C4 corresponding to the incident angle of 30 degrees is 522 nm. The wavelength of the spectral curves C4 shifts by 30 nm relative to the wavelength of the spectral curves C3 at the 50% transmittance.

### Third example

In the four film sets 30 of the optical film structure 3 of the third example, the thickness of at least two film sets 30 can be different, for example, and the thickness ratio of the first film 31 to the second film 32 of each film set 30 is different. For the film set 30_1, the thickness of the first film 31 is about 0.1089 times of ¼λ, and the thickness of the second film 32 is about 3.9434 times of ¼λ. For the film set 30_2, the thickness of the first film 31 is about 0.0895 times of ¼λ, and the thickness of the second film 32 is about 6.182 times of ¼λ. For the film set 30_3, the thickness of the first film 31 is about 0.1861 times of ¼λ, and the thickness of the second film 32 is about 2.1758 times of ¼λ. For the film set 30_4, the thickness of the first film 31 is about 0.2396 times of ¼λ, and the thickness of the second film 32 is about 3.8189 times of ¼λ.

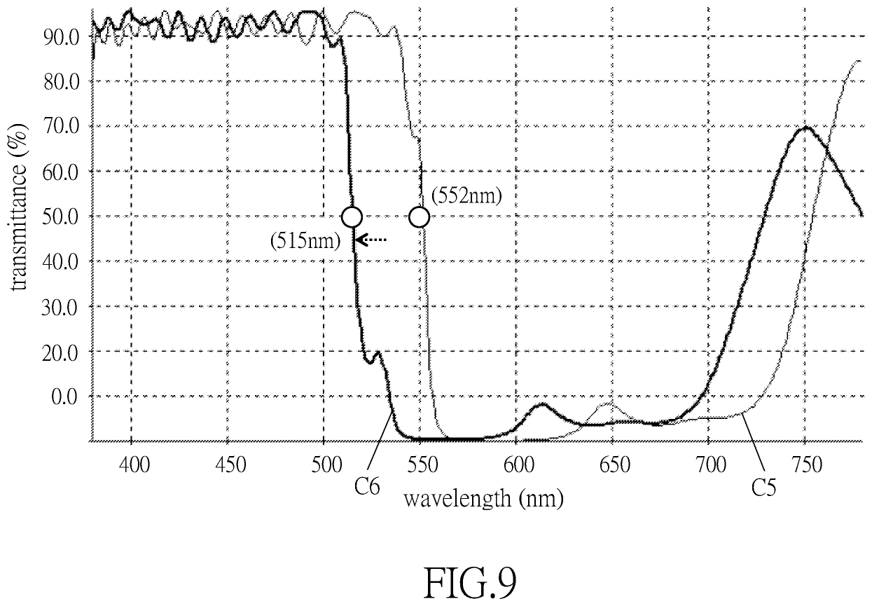

The transmittance test is to set the optical film structure 3 of the third example in the test environment as shown in FIG. 2, and then illuminate the optical film structure 3 with light with a reference wavelength of 530 nm and the incident angles of 0 and 30 degrees respectively. The test results are shown in FIG. 9, where the wavelength corresponding to the 50% transmittance in the spectral curves C5 corresponding the incident angle of 0 degree is 552 nm, and the wavelength corresponding to the 50% transmittance in the spectral curves C6 corresponding the incident angle of 30 degrees is 515 nm. The wavelength of the spectral curves C6 shifts by 37 nm relative to the wavelength of the spectral curves C5 at the 50% transmittance.

It can be seen from the above tests that the greater the thickness difference between the first film 31 and the second film 32 of each film set 30, the more obvious the spectral shift may become. The smaller the thickness ratio of the first film 31 to the second film 32 of each film set 30, the more obvious the spectral shift may become. Stacking at least two film sets 30 with different thickness ratios of the first film 31 to the second film 32 may also make the spectral shift more obvious.

Although the invention is disclosed as above with the aforementioned embodiments, these embodiments are not intended to limit the invention. Without departing from the spirit and scope of the invention, the combination of changes, retouching and various embodiments belongs to the scope of claims of the invention. For the scope of protection defined by the invention, please refer to the attached claims.

What is claimed is:

1. An optical film structure comprising a plurality of film sets stacked along an axis, and each film set of the plurality of film sets including a first film and a second film which are stacked, wherein for each film set of the plurality of film sets, a refractive index of the first film is greater than a refractive index of the second film, and a thickness ratio of the first film to the second film is greater than 0 and less than or equal to 0.28.

2. The optical film structure as claimed in claim 1, wherein in one film set of the plurality of film sets, the thickness ratio of the first film to the second film is 0.01˜0.27.

3. The optical film structure as claimed in claim 1, wherein in one film set of the plurality of film sets, a thickness of the first film is 0.08-0.50 times of a quarter of a wavelength of incident light, and a thickness of the second film is 1.80-6.20 times of a quarter of the wavelength of the incident light.

4. The optical film structure as claimed in claim 1, wherein in one film set of the plurality of film sets, a thickness of the first film is less than or equal to 0.5 times of one quarter of a wavelength of incident light, and a thickness of the second film is greater than or equal to 1.80 times of one quarter of the wavelength of the incident light.

5. The optical film structure as claimed in claim 4, wherein in each film set of the plurality of film sets, the thickness of the first film is less than or equal to 0.5 times of one quarter of the wavelength of the incident light, and the thickness of the second film is greater than or equal to 1.80 times of one quarter of the wavelength of the incident light.

6. The optical film structure as claimed in claim 1, wherein in one film set of the plurality of film sets, a thickness of the first film is 0.2 times of a quarter of a wavelength of incident light, and a thickness of the second film is 2 times of a quarter of the wavelength of the incident light.

7. The optical film structure as claimed in claim 1, wherein in one film set of the plurality of film sets, a material of the first film is titanium dioxide, tantalum pentoxide, niobium pentoxide, silicon oxide, silicon nitride, tin dioxide or zinc sulfide, and a material of the second film is silicon dioxide, magnesium fluoride, barium fluoride, aluminum fluoride or strontium fluoride.

8. The optical film structure as claimed in claim 1, wherein the first film of each film set of the plurality of film sets contacts the second film of another film set of the plurality of film sets that is adjacent thereto.

9. The optical film structure as claimed in claim 1, wherein the thickness ratio of the first film to the second film of each film set of the plurality of film sets is the same.

10. The optical film structure as claimed in claim 1, wherein the thickness ratio of the first film to the second film of one film set of the plurality of film sets is different from the thickness ratio of the first film to the second film of another film set of the plurality of film sets.
